(19) United States
(12) Patent Application Publication
(10) Pub. No.: US 2014/0090655 A1
(43) Pub. Date: Apr. 3, 2014

(54) Flavored Boil and Bite Mouthguard

(71) Applicant: Yvette Robinson, El Paso, TX (US)

(72) Inventor: Yvette Robinson, El Paso, TX (US)

(21) Appl. No.: 14/042,832

(22) Filed: Oct. 1, 2013

Related U.S. Application Data
(60) Provisional application No. 61/708,695, filed on Oct. 2, 2012.

(51) Int. Cl. A63B 71/08; B29C 39/02

(52) U.S. Cl. CPC A63B 71/085; B29C 39/026
USPC 128/862; 264/16

(57) ABSTRACT

A mouthguard device and method of manufacturing is provided, wherein the mouthguard provides the wearer with protection typically provided by most mouthguard structures, while providing an embedded flavor in the mouthguard material that the wearer can taste to mask the otherwise foul smell of a used mouthguard over the course of its use. A flavorant is infused within the thermoplastic material, which is perceptible to the wearer and reduces its smell and bad taste. The method of manufacturing involves infusing flavorant within the thermoplastic material and thereafter providing the mouthguard structure to the user such that it can be molded to the wearer's mouth using a boil and bite technique.

### CROSS REFERENCE TO RELATED APPLICATION

This application claims the benefit of U.S. Provisional Application No. 61/708,695 filed on Oct. 2, 2012, entitled “Flavor Guard.” The above identified patent application is herein incorporated by reference in its entirety to provide continuity of disclosure.

### BACKGROUND OF THE INVENTION

### FIELD OF THE INVENTION

The present invention relates to oral mouthguards utilized to protect a wearer's teeth and jaw from direct impacts and impacts that cause concussions to the wearer. More specifically, the present invention pertains to a boil and bite type mouthguard for athletic use and a method of making the same that involves infusing flavorants therein for improved taste and smell over the course of its use.

Mouthguards are oral appliances that are utilized in many different settings and for different applications. Some mouthguards are utilized to treat oral maladies related to the jaw and teeth of the wearer, while others relate to protection of the wearer's teeth and for use preventing concussions during heightened activity. The latter type is widely used in athletics, and particularly in those sporting activities that involve collisions and impacts to the wearer's body. The mouthguard serves two functions in this setting: protecting the user's teeth from direct impacts, and arguably more importantly, for preventing head concussions to the wearer by controlling the wearer's mandible. The mouthguard effectively repositions the wearer's mandible such that load imparted on the head and neck is attenuated during direct mandible strikes and indirect body blows. It is postulated that the attenuated energy lowers the concussive impact to the head and neck.

One major drawback to most mouthguards is that they tend to become quite filthy over a period of use. Repeated placement and removal into the oral cavity causes saliva, bacteria, and other elements to quickly turn a fresh mouthguard into a smelly, foul-tasting article that the wearer is forced to place in his or her mouth to be effective. It is not uncommon for wearers to splash the mouthguards with water or regularly remove the mouthguard between uses, as the appliance is likely foul tasting and foul smelling. This can be off-putting to the wearer, and functions as an annoyance to continued and regular use on the playing field. Periods in which the mouthguard is not donned are periods in which the user's mouth and jaw are subject to harm that could otherwise be attenuated or outright prevented.

Most common solutions to this known drawback is the frequent replacement of mouthguards over the course of a season or between games. For those with the funds and the capacity, this is an effective solution. For those without the means, or for those that require specifically fitted mouthguard appliances, this solution is not practical. Therefore, an alternative solution is desired that eliminates or reduces the “bad breath” smell and taste of a used mouthguard, wherein the solution does not involve discarding the article in favor of a replacement.

The most common form of mouthguards and the type herein contemplated is the inexpensive “boil and bite” type mouthguard. This type is also known as the mouth-adapted type mouthguard. This type of mouthguard is one that is designed to be universal and one that can be fitted or tailored to a specific wearer's teeth without professional assistance. The mouthguard is comprised of a thermoplastic material that is heated and thereafter molded to the wearer's teeth geometry by placement into the oral cavity and compression of the appliance by biting action. The material is first boiled in hot water, removed and formed in the wearer's mouth, and cooled to a set configuration that conforms to the user's upper and lower bite.

The present invention contemplates a new boil and bit mouthguard that infuses a flavor into the mouthguard material during the production process, wherein the flavor is then tasted by the wearer over the course of use to reduce the foul taste thereof. During the production of the boil and bite mouthguard device, a flavorant is added to the thermoplastic material such that a palpable flavor is detected when donned. The flavorant acts to mask the otherwise foul-smell of the mouthguard over its use and does not break down boiled and formed to the wearer's mouth. Overall, the device improves the wearer's willingness to repeatedly use a mouthguard, rather than leaving it out or continually replacing the article over the course of a season.

### DESCRIPTION OF THE PRIOR ART

Devices have been disclosed in the prior art that relate to mouthguard structures. These include devices that have been patented and published in patent application publications, and generally relate to those with unique structural features for a given purpose. The present invention contemplates an infused flavor during a production of a bite and boil mouthguard for improved taste and smell thereof during use. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Patent Publication No. 2003/0075184 to Persichetti discloses a user-formable, wax based mouthguard having an arch-shaped baseplate and an impression layer. The impression layer is formed of a wax material and can be formed to the wearer's teeth geometry. The wax may incorporate an additive artificial flavor and a color. The Persichetti device is one that contemplates a disposable mouthguard suitable for single use, rather than one for continued use. The present invention contemplates a traditional boil and bit mouthguard structure that includes an infused flavorant therein.

U.S. Pat. No. 6,068,475 to Stoyka, Jr. discloses a flavored and medicated mouthpieces that is adapted to cause salivation from the user for the purposes of dispensing medication into the oral cavity to treat wounds and sores therein. The mouthpiece is a U-shaped member having a flavored coating thereon or a layer of medicine applied thereto. Within the U-shaped member is a hollow interior within which a medicine is adapted to be placed and dispensed therefrom. While disclosing a flavored mouthpiece, the Stoyka, Jr. device contemplates a coating of flavoring, rather than a flavorant that is infused in the forming of the mouthpiece, as contemplated herein.

U.S. Patent Publication No. 2007/0151568 to Maurello discloses a mouthguard that is adapted to fit tightly and properly against the wearer's teeth using a plurality of cilia that project inward from the mouthguard and towards the wearer's teeth. The device is U-shaped and includes a plurality of flexible extensions that are formable to the dentition of the wearer without first boiling the device. The Maurello also contemplates the mouthguard to take on a flavor for the user to taste using flavor crystals. The present invention contemplates a flavorant added to the thermoplastic during the formation process as it is formed into its U-shaped channel shape.

U.S. Pat. No. 7,328,706 to Bardach discloses a U-shaped dental device that includes a channel for forming around the wearer's teeth. A discrete insert is adapted to fit into an inset within the channel for gradual release of a beneficial agent, such as a medication, breath freshener, flavor of the like. The insert releases the agent and is supported within the channel of the dental device. The Bardach device contemplates the use of a removable and deployable insert within a mouthpiece or mouthguard device for the purposes of releasing an agent. The present invention contemplates a mouthguard material infused with a flavor to reduce smell and foul taste thereof.

Finally, U.S. Patent Publication No. 2007/0235039 to Gottsch discloses a mouthguard device for use by an athlete that includes a resilient material formed into a U-shaped mouthguard device. A flavor agent is incorporated into the material prior to formation thereof for providing a given flavor to the mouthguard in a tray that contacts the user's taste buds. The preferred configuration utilizes an inner and outer tray to form the mouthguard structure, the tray closest to the wearer's taste buds being flavored for improved taste thereof. The present invention contemplates a molded, singular tray thermoplastic that includes an infused flavor that provides uniform flavoring about the entire structure.

The present invention provides a mouthguard device that provides the wearer with a taste and smell that is directed to a given flavor. The device is infused with the flavor and gives off the flavor over the course of its use, reducing the foul smell and bad flavor associated with most mouthguard devices used by athletes. It is submitted that the present invention substantially diverges in design elements from the prior art, and consequently it is clear that there is a need in the art for an improvement to existing mouthguard devices. In this regard the instant invention substantially fulfills these needs.

### SUMMARY OF THE INVENTION

In view of the foregoing disadvantages inherent in the known types of mouthguard devices now present in the prior art, the present invention provides a new athletic mouthguard device and method of manufacturing that provides the user with a flavored and scented mouthguard device for prolonged use.

It is therefore an object of the present invention to provide a new and improved mouthguard device that has all of the advantages of the prior art and none of the disadvantages.

It is another object of the present invention to provide a mouthguard structure that comprises a U-shaped construction having an elongated channel to form around the wearer's teeth, wherein the material of the mouthguard structure is infused with a flavor and scent.

Another object of the present invention is to provide a mouthguard device that comprises a thermoplastic material having infused flavorant, wherein the mouthguard is formed to the wearer's teeth using the traditional boil and bite technique.

Yet another object of the present invention is to provide that provides a long lasting flavor to combat foul smells and tastes from the device over repeated use.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exemplary embodiment of the mouthguard structure of the present invention.

### DETAILED DESCRIPTION OF THE INVENTION

Reference is made herein to the attached drawings. Like reference numerals are used throughout the drawings to depict like or similar elements of the flavored mouthguard device. For the purposes of presenting a brief and clear description of the present invention, the preferred embodiment will be discussed as used for providing a favorable flavor and scent for the mouthguard when donned. The figures are intended for representative purposes only and should not be considered to be limiting in any respect.

The present invention is a mouthguard structure having a substantial U-shape construction formed to match the general profile of a wearer's bite. The U-shaped device includes an interior channel having a base surface and a pair of upstanding walls adapted to accept the teeth of a wearer. When fitting the device to the wearer's specific bite geometry, the device is heated in boiling water and then placed into the wearer's mouth. The wearer bites down on the device to press his or her teeth into the softened material of the channel. Impressions are made into the heated material, which then cools and retains the impression shape. This matches the outer profile the wearer's teeth and allows the device to be closely formed thereto for better fitment. This style of mouthguard is known as the boil and bite style, wherein the material of the mouthguard is one of thermoplastic material that can be heated and formed into different shapes.

During the manufacturing of the mouthguard, the thermoplastic material is molded into the generic U-shape having the elongated channel therein without any impressions. Heated thermoplastic material is flowed into a mold before being released in the formed shape and released to be cooled. The present invention contemplates the use of a flavorant that is mixed into the flowing thermoplastic material. Flavor additives such as artificial sweeteners, breath freshener material, and food flavoring agents, simple sugars and salts can be combined into the thermoplastic material such that when the device is donned by the wearer, the plastic retains a flavor and scent associated with the added flavorant.

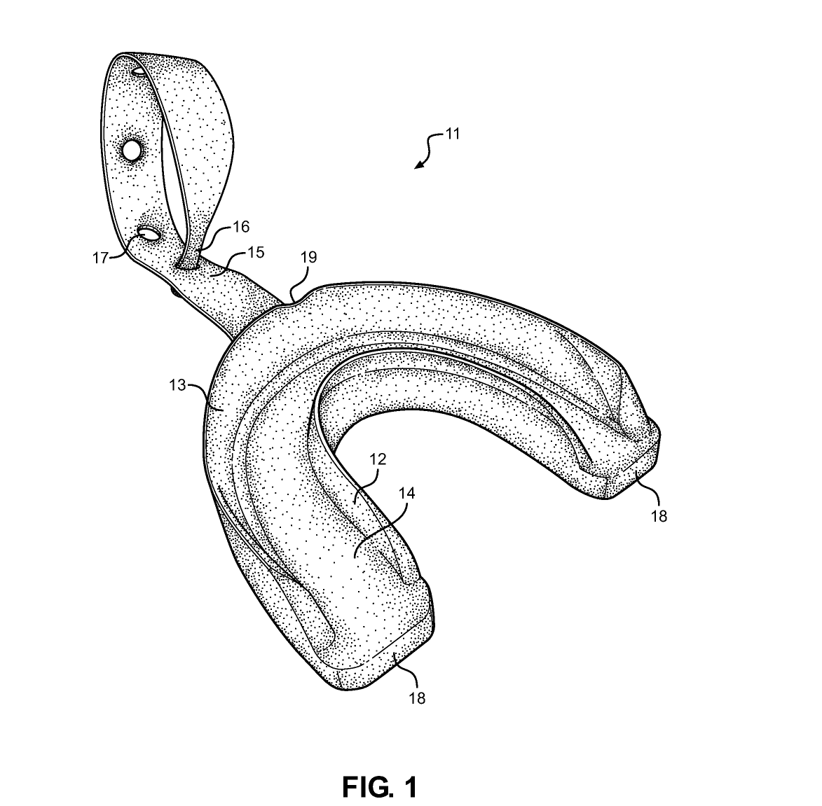

Referring now to FIG. 1, there is shown an overhead perspective view of an exemplary embodiment of the present invention. The mouthguard 11 comprises a substantial U-shape having a first and second rear end 18 and an elongated, curving length comprised of an inner upstanding surface 12, a base surface 14, and an outer upstanding surface 13. Along the forward portion 19, or apex of the mouthguard is an optional tether 15 member that is utilized to secure the mouthguard to a helmet. The tether 15 includes an elongated length having a plurality of apertures 17 therealong, through which the distal end 16 of the tether is adapted to be placed and secured. This forms a closed loop tether 15 secured about another structure (helmet face mask or the like).

The device comprises of a conventional mouth guard that includes a flavor as part of the device. The addition of flavoring helps to encourage use of the mouth guard in order to protect the teeth of the user. The mouth guard of the present invention comprises a protective, flavored mouth guard, made from thermoplastic material molded into its shape and infused with flavorant during prior to the forming process. The flavor is deposited directly into the mouth guard material and can vary greatly, depending on user preference. Dies and colorings can also be added to mouthguard to correspond with the chosen flavor.

The preferred method involves adding a flavoring agent to a thermoplastic material, molding the material into a general U-shaped mouthguard structure, and providing the structure to the user to form to his or her specific mouth. The flavoring agents include artificial sweeteners, flavor crystals, breath freshening flavorants, sugars, and salts to provide a flavor that offsets the foul smell of a traditional used mouthguard.

The present invention describes a mouth guard that can be used by athletes that includes an infused flavor. The present invention provides athletes and other people with a more pleasurable experience while wearing a mouth guard, can be offered in a variety of flavors, and decreases the occurrence of dry mouth due to adrenaline release.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A method of producing a flavored boil and bite mouthguard device, comprising the steps of:
preparing a thermoplastic material in molten form;
adding a flavoring agent to said thermoplastic material;
adding a coloring agent that is adapted to match said flavoring agent to said thermo plastic material;
forming said thermoplastic material into a substantial U-shape having a channel therein.

2) A boil and bite mouthguard device, comprising:
a substantially U-shaped mouthguard comprising an elongated channel having a base surface and an inner and outer upstanding surface;
said U-shaped mouthguard comprising a thermoplastic material;
a flavoring agent infused within said thermoplastic material;
said mouthguard having a coloring agent matching said flavoring agent.
